(19) United States
(12) Patent Application Publication
(10) Pub. No.: US 2018/0117798 A1
(43) Pub. Date: May 3, 2018

(54) MOLDING DIE AND MOLDING METHOD

(71) Applicant: YAZAKI CORPORATION, Tokyo (JP)

(72) Inventors: Akira Sato, Shizuoka (JP); Kenji Takahashi, Shizuoka (JP); Teruo Kato, Aichi (JP); Yusuke Hinoda, Aichi (JP)

(21) Appl. No.: 15/851,928

(22) Filed: Dec. 22, 2017

Related U.S. Application Data
(63) Continuation of application No. PCT/JP2016/072019, filed on Jul. 27, 2016.

(30) Foreign Application Priority Data
Jul. 27, 2015 (JP) 2015-147367

(51) Int. Cl. B29C 33/42; B29C 33/00; B29C 33/44

(52) U.S. Cl. CPC B29C 33/42; B29C 33/44; B29C 33/005

(57) ABSTRACT

A molded product having an annular groove on an outer circumferential surface is molded by a mold. The mold includes three or more mold blocks. Each of the mold blocks includes a parting surface, a concave surface for molding a part of the outer circumferential surface, and a projection for molding a part of the annular groove. In each of the mold blocks, the parting surface extends in a direction of a normal line of the concave surface at a position where the parting surface and the concave surface intersect to each other.

### CROSS REFERENCE TO RELATED APPLICATIONS

This application is a continuation of PCT application No. PCT/JP2016/072019, which was filed on Jul. 27, 2016 based on Japanese Patent Application No. 2015-147367 filed on Jul. 27, 2015, the contents of which are incorporated herein by reference.

### TECHNICAL FIELD

The present invention relates to a mold and a molding method.

### BACKGROUND ART

Conventionally, a mold for molding a cylindrical body having an annular groove (a concave) on an outer circumferential surface has a concave surface for molding the outer circumferential surface of the cylindrical body and an annular convex formed on the concave surface for molding the annular groove. Therefore, the molded cylindrical body cannot be extruded and brought out in an axial direction of the mold. Accordingly, the mold is divided into a plurality of mold components (called “mold blocks” below) on a surface including the axial direction. At the time of molding, parting surfaces are pressed to each other, and when the molded cylindrical body is brought out, the mold blocks are moved in a direction perpendicular to the axial direction (a radial direction) so that the parting surfaces are separated.

Therefore, when the parting surfaces are pressed to each other, in a case where there is a step between a parting surface of one mold block and a parting surface of the other mold block, the step is molded and transcribed to the cylindrical body, and an axial step (called “parting line” below, sometimes abbreviated as “PL”) is formed on the outer circumferential surface and the annular groove of the molded cylindrical body.

In particular, in a case in which an annular seal member (oil seal or the like) is attached to the annular groove and a sealability is demanded to be maintained in the cylindrical body, if the PL is high (if the step is large), a gap occurs between the annular groove and the seal member, and it becomes impossible to maintain the sealability.

Therefore, an invention has been disclosed that instead of attaching the seal member to the annular groove, at first, a cylindrical body having an annular groove is primarily molded, and then, an annular seal member burying the annular groove and protruding from the outer circumferential surface is secondarily molded (refer to Patent Document 1).

Patent Document 1: JP-A-2014-10996 (Page 5-6, FIG. 3)

The invention disclosed in Patent Document 1 (a molding method of a connector) does not relate to height of PL, and a primarily molded annular groove and a secondarily molded annular seal member closely contact to each other. Therefore, man-hours of attaching a seal member to an annular groove are reduced, and a sealability is maintained.

However, the invention disclosed in Patent Document 1 requires molding twice. Since this requires molding time and molds, there have been requests of reducing the height of PL by simple molding.

### SUMMARY OF THE INVENTION

In accordance with one or more embodiments, a mold and a molding method reduces height of PL of a molded product by simple molding.

In accordance with one or more embodiments, a mold for molding a molded product having an annular groove on an outer circumferential surface includes three or more mold blocks. The mold blocks respectively include parting surfaces abutting on each other separately, concave surfaces for molding parts of the outer circumferential surface, and projections for molding parts of the annular groove. In each of the mold blocks, the parting surface may extends in a direction of a normal line of the concave surface at a position where the parting surface and the concave surface intersect.

In accordance with one or more embodiments, the molded product may have a cylindrical part including the annular groove. The mold may have a first mold block including a concave surface for molding a ½ range of the outer circumferential surface of the cylindrical part and a projection for molding a ½ range of the annular groove, a second mold block including a concave surface for molding a range on one side of the outer circumferential surface of the cylindrical part in ranges except for the range to be molded by the first mold block and a projection for molding a range on one side of the annular groove in ranges except for the range to be molded by the first mold block, and a third mold block including a concave surface for molding a range on the other side of the outer circumferential surface of the cylindrical part in the ranges except for the range to be molded by the first mold block and a projection for molding a range on the other side of the annular groove in the ranges except for the range to be molded by the first mold block. In the second mold block, the parting surface abutting on the third mold block may extends in a direction of a normal line of the concave surface at a position where the parting surface and the concave surface intersect. In the third mold block, the parting surface abutting on the second mold block may extends in a direction of a normal line of the concave surface at a position where the parting surface and the concave surface intersect.

In accordance with one or more embodiments, in a molding method of molding a molded product including an annular groove on an outer circumferential surface by a mold, the mold has three or more mold blocks. The mold blocks include parting surfaces abutting on each other, concave surfaces for molding parts of the outer circumferential surface, and projections for molding parts of the annular groove. In each of the mold blocks, the parting surface is formed in a direction of a normal line of the concave surface at a position where the parting surface and the concave surface intersect. The molding method includes a process of abutting the parting surfaces on each other and molding the molded product, and a process of separating the parting surfaces from each other and bringing out the molded product.

According to embodiments, the parting surfaces are formed in the directions of the normal lines of the concave surface at the positions where the parting surfaces and the concave surface intersect to each other. That is, since the parting surfaces are formed perpendicular to tangent lines of the concave surface (as “parted perpendicularly”), in a case where discrepancy of projections between the mold blocks occurs in abutment positions of the parting surfaces, such discrepancy becomes a step in the normal line direction of the concave surfaces. However, since such a step is a step in the perpendicular direction, a finishing tool can reach a step part, so it is possible to make a finishing process certain in mold manufacturing and to eliminate such a step. Therefore, it is possible to control the height of the PL in the annular groove of the molded product, in a case of attaching the seal member to such a annular part, since the seal member closely contacts to the annular groove, a sealability is maintained. At this time, since molding is finished by a single molding step, the number of molds decreases compared with the invention disclosed in Patent Document 1. In addition, since the molding process becomes simple, molding time is shortened and workability (productivity) is improved.

### BRIEF DESCRIPTION OF DRAWINGS

FIG. 1 is a side view of a connector to be molded, for explaining a mold according to a first embodiment of the invention.

FIG. 2 is a front view of the connector to be molded, for explaining the mold according to the first embodiment of the invention.

FIG. 3 illustrates the mold according to the first embodiment of the invention, and is a front cross-sectional view in molding.

FIG. 4 illustrates the mold according to the first embodiment of the invention, and is a front cross-sectional view after molding.

FIG. 5 is a front view showing a finishing process of the mold, for explaining an action effect of the mold according to the first embodiment of the invention.

FIG. 6 is a front view showing a finishing process of a comparing mold, for explaining the action effect of the mold according to the first embodiment of the invention.

FIG. 7 illustrates a molding method according to a second embodiment of the invention, and is a front view showing a process of bringing out a molded product.

### DESCRIPTION OF EMBODIMENTS

Embodiments of the invention (called “embodiments” below) will be described with reference to the drawings. Hereinafter, as a molded product, a connector for electrically connecting an inside and an outside of various apparatus such as an engine room, a transmission and a fuel tank of an automobile is described as an example, but the invention is not limited to connectors. In addition, even if the molded product is a connector, it is not limited to the illustrated embodiment, and for example, may be a connector not having a rib to be described later.

### <First Embodiment>

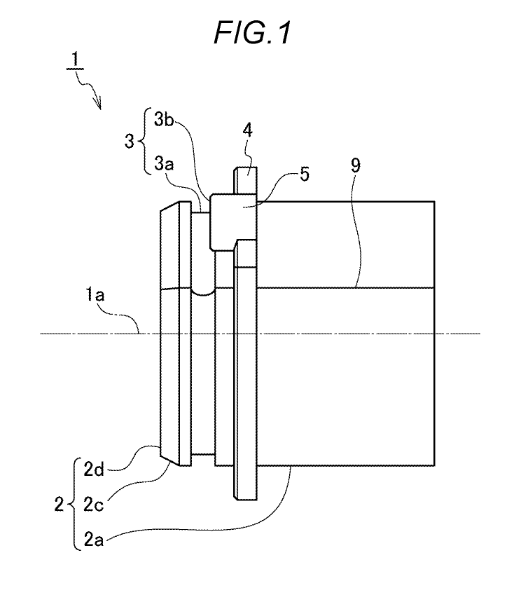

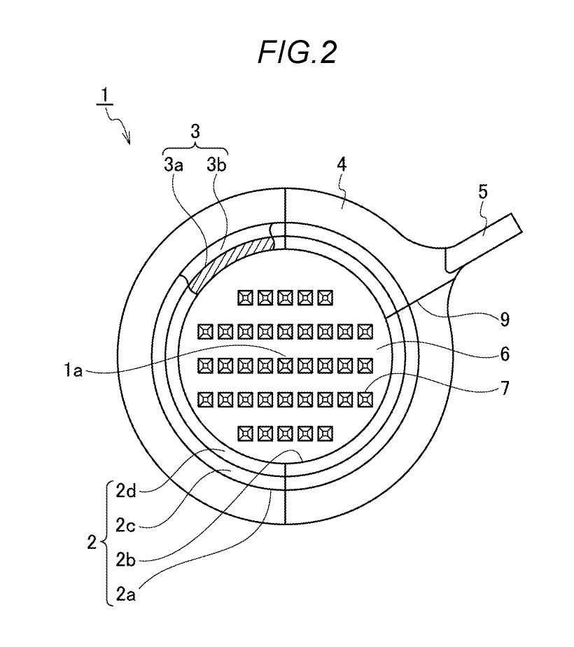

FIG. 1 and FIG. 2 are figures for explaining a mold according to the first embodiment of the invention, FIG. 1 is a side view showing a molded connector, and FIG. 2 is a front view showing the molded connector.

### (Connector)

In FIG. 1 and FIG. 2, a connector 1 has a cylindrical part 2 where a chamfered part 2c is formed on an outer circumference of one end surface 2d, a circular groove 3 which is an annular groove formed on an outer circumferential surface 2a of the cylindrical part 2, a flange 4 which is formed across the whole circumference of the outer circumferential surface 2a, and a rib 5 which is formed on the flange 4 and projects to a prescribed direction. On an inner circumferential surface 2b of the cylindrical part 2, a partition wall 6 liquid-tightly partitioning the inside of the cylindrical part 2 in the direction of the central axis 1a is formed. A relay terminal 7 penetrating the partition wall 6 is insert-molded in the partition wall 6.

In the circular groove 3, a seal member not shown (called “oil seal” below) is attached. The cylindrical part 2 is inserted from the chamfered part 2c side into a mounting cylinder (not shown) provided in the engine room of an automobile and the like. The oil seal liquid-tightly abuts on an inner circumferential surface of the mounting cylinder.

There are cases where a parting line (called “PL” below) 9 (parallel to the central axis 1a on the outer circumferential surface 2a) corresponding to abutment surfaces of mold blocks configuring a mold for molding the outer circumferential surface 2a, the circular groove 3, the flange 4 and the rib 5 is visually recognized on the outer circumferential surface 2a, the circular groove 3, the flange 4 and the rib 5, and there are cases where it is not visually recognized.

For convenience of the following description, a bottom surface of the circular groove 3 (a surface parallel to the central axis 1a) is explained as a groove bottom surface 3a, a lateral surface of the circular groove 3 (a surface perpendicular to the central axis 1a) is explained as a groove lateral surface 3b, and a radius of a boundary of the end surface 2d and the chamfered part 2c is explained as the same as a radius of the groove bottom surface 3a. However, the size of the chamfered part 2c or the depth of the circular groove 3 (the radius of the groove bottom surface 3a) may be suitably selected.

### (Mold)

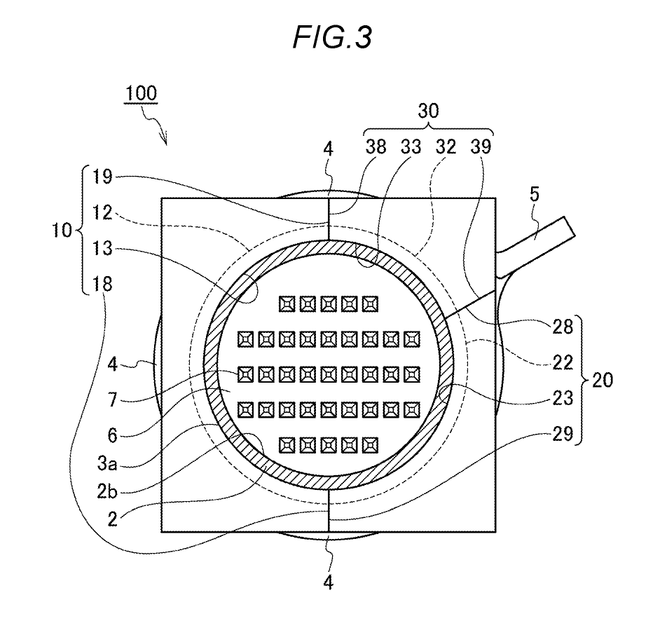

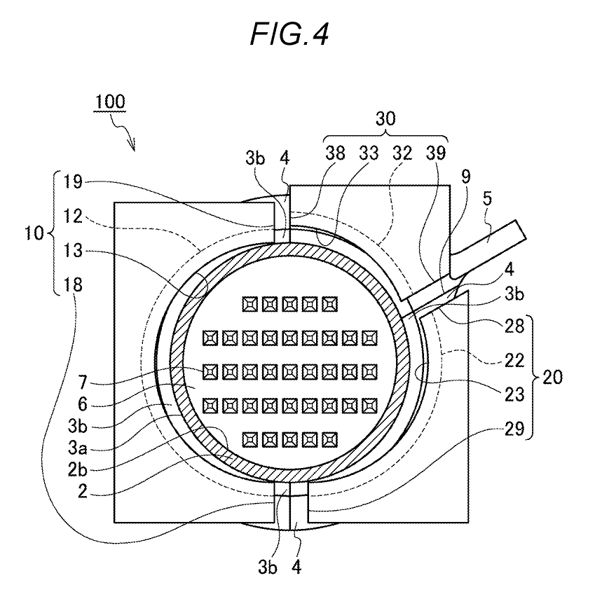

FIG. 3 and FIG. 4 illustrate the mold according to the first embodiment of the invention, FIG. 3 is a front cross-sectional view in molding, and FIG. 4 is a front cross-sectional view after molding.

In FIG. 3 and FIG. 4, a mold 100 has a first mold block 10, a second mold block 20 and a third mold block 30 which are relatively slidable to each other. At this time, for example, the second mold block 20 may be fixed.

The first mold block 10 includes a concave surface 12 whose cross-section is arc (shown by a broken line) for molding a ½ range of the outer circumferential surface 2a of the cylindrical part 2 of the connector 1 and a projection 13 for molding a ½ range of the circular groove 3 (left side in FIG. 2). Parting surfaces 18, 19 are positioned in an identical plane containing the center of the concave surface 12 (arc).

The second mold block 20 is relatively movable perpendicular to the parting surface 18 of the first mold block 10. The second mold block 20 includes a concave surface 22 (shown by a broken line) for molding a range on one side (the lower right side in FIG. 2) of the outer circumferential surface 2a of the cylindrical part 2 in a range except for the ½ range, a projection 23 for molding a range on one side (the lower right side in FIG. 2) of the circular groove 3 in a range except for the ½ range, and a concave part (not shown) for molding a part on one side (the lower side in FIG. 2) of the rib 5.

The third mold block 30 is relatively movable to the parting surface 19 of the first mold block 10 in two directions, that is a direction parallel with and a direction perpendicular to the parting surface 19 of the first mold block 10. The third mold block 30 includes a concave surface 32 (shown by a broken line) for molding a range on the other side (the upper right side in FIG. 2) of the outer circumferential surface 2a of the cylindrical part 2 in the range except for the ½ range, a projection 33 for molding a range on the other side (the upper right side in FIG. 2) of the circular groove 3 in the range except for the ½ range, and a concave part (not illustrated) for molding a part on the other side (the upper side in FIG. 2) of the rib 5.

Each of the first mold block 10, the second mold block 20 and the third mold block 30 includes a concave part (a concave part in a range taken charge by each of them, not shown) forming a cavity for molding the flange 4. As the mold 100 forms the inner circumferential surface 2b, the end surface 2d of the cylindrical part 2, and the partition wall 6 the mold 100 and insert-molds the relay terminal 7, the mold 100 has a fourth mold block and a fifth mold block (moves relatively in a direction perpendicular to the page space in FIG. 3; not shown). Since these are conventional technologies, description is omitted for convenience.

For convenience of description, FIG. 3 and FIG. 4 illustrate a part of the first mold block 10, the second mold block 20 and the third mold block 30, and clarify a position relationship between the flange 4 and the rib 5.

Further, in the second mold block 20, a parting surface 28 abutting on the third mold block 30 is formed in a direction of a normal line of the concave surface 22 at a position where the parting surface 28 and the concave surface 22 intersect to each other. That is, in a front view, the concave surface 22 is an arc and the parting surface 28 is formed (parted perpendicularly) in a radial direction (same as a diameter direction) from a center of the arc not shown (that is, perpendicular to a tangent line of the arc).

Similarly, in the third mold block 30, a parting surface 39 abutting on the second mold block 20 is formed in a direction of a normal line of the concave surface 32 at a position where the parting surface 39 and the concave surface 32 intersect to each other. That is, in a front view, the concave surface 32 is an arc, the parting surface 39 is formed (parted perpendicularly) in a radial direction (a diameter direction) from a center of the arc not shown (that is, perpendicular to a tangent line of the arc).

### (Action Effect)

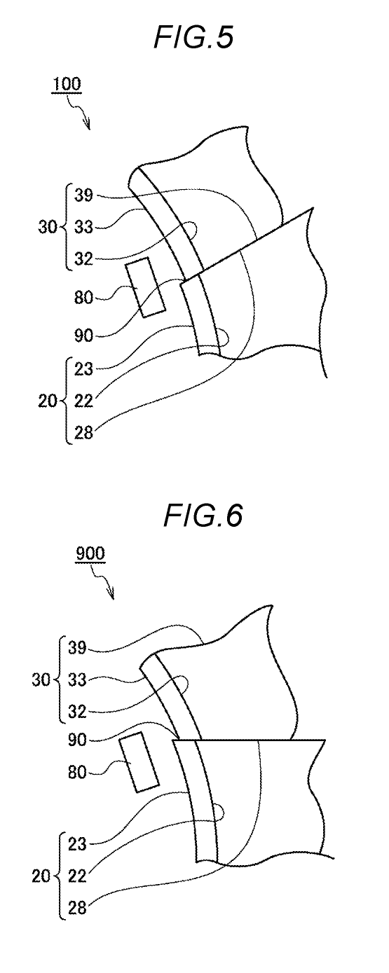

FIG. 5 and FIG. 6 illustrates an action effect of the mold according to the first embodiment of the invention, FIG. 5 is a front view showing a finishing process of the mold, and FIG. 6 is a front view showing a finishing process of a comparing mold.

In FIG. 5, in the mold 100, at the time of mold matching in mold manufacture, the concave surface 12, the concave surface 22 and the concave surface 32 continuously form a round hole (at this time, similarly, apexes of the projection 13, the projection 23 and the projection 33 continuously form a round hole, refer to FIG. 3). Further, in a case where the parting surface 28 of the second mold block 20 abuts against the parting surface 39 of the third mold block 30 and a step 90 (discrepancy of the abutment surface of the projection 23 projecting from the concave surface 22 and the projection 33 projecting from the concave surface 32) is generated, the projection 23 and the projection 33 are removed for finishing the mold by a finishing tool 80 such as a grindstone from an inner surface of the round hole.

Therefore, since the mold 100 is parted perpendicularly as described above, the step 90 is perpendicular to the concave surface 22 and the concave surface 32, there is no possibility that a place arises where the finishing tool 80 for mold finishing cannot reach and the finishing cannot be done.

In FIG. 6, as comparison, if the mold 100 is not parted perpendicularly as conventional molds (called “mold 900” below), the step 90 caused by the abutment between the parting surface 28 of the second mold block 20 and the parting surface 39 of the third mold block 30 is not perpendicular to but inclined to the concave 22 surface and the concave surface 32. Therefore, there is a possibility that the mold 900 has a place where the finishing tool 80 for mold finishing cannot reach and the finishing cannot be done.

From the above, since the mold 100 according to the first embodiment is parted perpendicularly, at the time of mold matching in mold manufacture, even if the step 90 is generated, since the step 90 can be machined by the finishing tool 80, the step 90 can be removed. As a result, in the connector 1 molded by the mold 100, since the height of PL9 is minimized and the seal member closely contacts to the circular groove 3 in a case of attaching the seal member to the circular groove 3, a sealability is maintained. Since molding is finished by a single molding step, the molding time is reduced, and the number of molds decreases compared with the invention disclosed in Patent Document 1.

### <Second Embodiment>

### (Molding Method)

Next, a molding method according to a second embodiment of the invention is described.

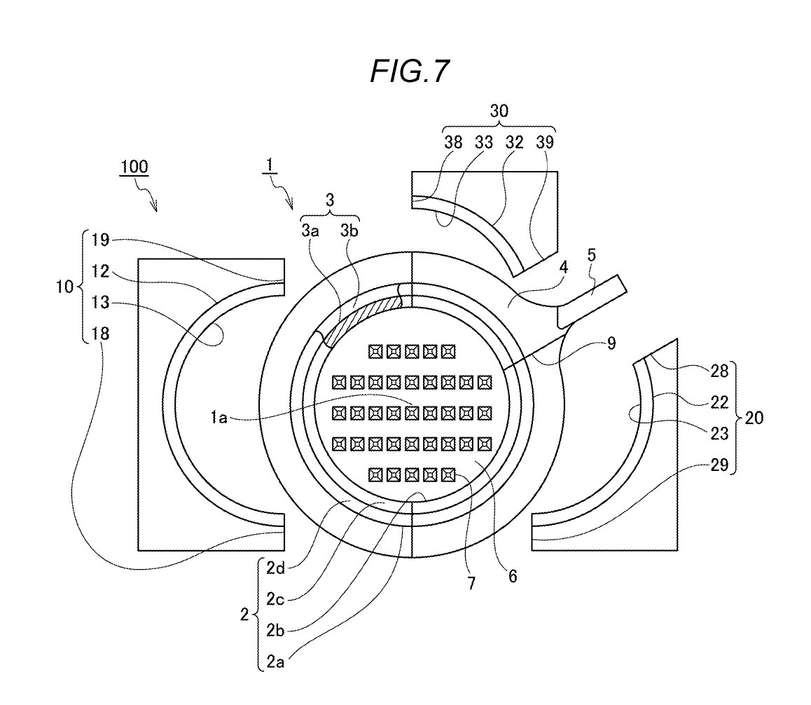

FIG. 7 illustrates a molding method according to the second embodiment of the invention, and is a front view showing a process of bringing out a molded product. The same parts as those in the first embodiment are denoted by the same reference numerals and the description is omitted.

The molding method includes a process of molding the connector 1 and a process of bringing out the molded connector 1.

That is, the process of molding the connector 1 includes: abutting the parting surface 18 of the first mold block 10 on the parting surface 29 of the second mold block 20, abutting the parting surface 28 of the second mold block 20 on the parting surface 39 of the third mold block 30, abutting the parting surface 38 of the third mold block 30 on the parting surface 19 of the first mold block 10, and in a state where a cylindrical cavity is formed, molding the connector 1 (refer to FIG. 3).

The process of bringing out the molded connector 1 includes: separating the parting surface 18 and the parting surface 29, separating the parting surface 28 and the parting surface 39, separating the parting surface 38 and the parting surface 19 (refer to FIG. 4), and bringing out the molded connector 1 in a movable state (refer to FIG. 7). FIG. 7 shows a situation of bringing out the molded connector 1 in a direction of the central axis 1a. However, the invention is not limited to this, the molded connector 1 may be brought out in a direction perpendicular or inclined to the central axis 1a.

Therefore, as described above, since the mold 100 can eliminate the step 90, in the molded connector 1 according to the molding method, the height of PL9 is minimized. In addition, in a case of attaching the seal member (not shown) to the circular groove 3, a sealability is maintained. At this time, since molding is finished by a single molding process, a molding time is shortened and workability (productivity) is improved.

The invention is described based on embodiments in which a connector is taken as an example of a molded body. The embodiments are examples, and the molded body is not limited to the connector. Additionally, it is understood by those skilled in the art that various modifications are possible for these components and their combination and such modifications are also within the scope of the invention.

Here, aspects of embodiments of the mold and molding method according to the invention may be briefly summarized and listed in the following [1] to [3] respectively.

[1] A mold (100) for molding a molded product (connector 1) having an annular groove (circular groove 3) on the outer circumferential surface (2a) includes three or more mold blocks (10, 20, 30). Each of the mold blocks including a parting surface (18, 19, 28, 29, 38, 39) abutting on each other, a concave surface (12, 22, 32) for molding a part of the outer circumferential surface, and a projection (13, 23, 33) for molding a part of the annular groove. In each of the mold blocks, the parting surface is formed in a direction of a normal line of the concave surface at a position where the parting surface and the concave surface intersect to each other.

[2] In the mold (100) according to the above [1], the molded product has a cylindrical part (2) including the annular groove. The mold (100) has a first mold block (10) including a concave surface (12) for molding a ½ range of the outer circumferential surface of the cylindrical part and a projection (13) for molding a ½ range of the annular groove. The mold (100) also has a second mold block (20) including a concave surface (22) for molding a range on one side of the outer circumferential surface of the cylindrical part in ranges except for the range where the first mold block is molded and a projection (23) for molding a range on one side of the annular groove in ranges except for the range where the first mold block is molded. The mold (100) also has a third mold block (30) including a concave surface (32) for molding a range on the other side of the outer circumferential surface of the cylindrical part in the ranges except for the range where the first mold block is molded and a projection (33) for molding a range on the other side of the annular groove in the ranges except for the range where the first mold block is molded. In the second mold block, the parting surface (28) abutting on the third mold block is formed in a direction of a normal line of the concave (22) at a position where the parting surface and the concave surface intersect to each other. In the third mold block, the parting surface (39) abutting on the second mold block is formed in a direction of a normal line of the concave surface (32) at a position where the parting surface and the concave surface intersect to each other.

[3] In a molding method of molding a molded product (connector) including an annular groove (circular groove 3) on the outer circumferential surface (2a) by a mold (100), the mold has three or more mold blocks (10, 20, 30). Each of the mold blocks includes parting surfaces (18, 19, 28, 29, 38, 39) abutting on each other, a concave surface (12, 22, 32) for molding a part of the outer circumferential surface, and a projection (13, 23, 33) for molding a part of the annular groove. In each of the mold blocks, the parting surface is formed in a direction of a normal line of the concave surface at a position where the parting surface and the concave surface intersect to each other. The molding method includes a process of abutting the parting surfaces on each other and molding the molded product, and a process of separating the parting surfaces from each other and bringing out the molded product.

As described above, in the mold according to embodiments, even although the step occurs on a parting surface, it is possible to eliminate the step in mold finishing. Therefore, since the PL height of a molded product can be reduced, the molded product can be widely used as a parting mold for molding various molded products, not being limited to the connector.

### DESCRIPTION OF REFERENCE NUMERALS

1: connector (molded product)

1a: central axis

2: cylindrical part

2a: outer circumferential surface

2b: inner circumferential surface

2c: chamfered part

2d: end surface

3: circular groove (annular groove)

3a: groove bottom surface

3b: groove lateral surface

4: flange

5: rib

6: partition wall

7: relay terminal

9: parting line (PL)

10: first mold block

12: concave surface

13: projection

18: parting surface

19: parting surface

20: second mold block

22: concave surface

23: projection

28: parting surface

29: parting surface

30: third mold block

32: concave surface

33: projection

38: parting surface

39: parting surface

80: finishing tool

90: step

100: mold

900: mold

What is claimed is:

1. A mold for molding a molded product having an annular groove on an outer circumferential surface, the mold comprising three or more mold blocks,
wherein each of the mold blocks includes a parting surface, a concave surface for molding a part of the outer circumferential surface, and a projection for molding a part of the annular groove,
wherein, in each of the mold blocks, the parting surface extends in a direction of a normal line of the concave surface at a position where the parting surface and the concave surface intersect to each other,
wherein the molded product has a cylindrical part including the annular groove,
wherein the mold includes:
a first mold block including a concave surface for molding a ½ range of an outer circumferential surface of the cylindrical part and a projection for molding a ½ range of the annular groove,
a second mold block including a concave surface for molding a range on one side of the outer circumferential surface of the cylindrical part in ranges except for the range to be molded by the first mold block and a projection for molding a range on one side of the annular groove in ranges except for the range to be molded by the first mold block, and
a third mold block including a concave surface for molding a range on the other side of the outer circumferential surface of the cylindrical part in the ranges except for the range to be molded by the first mold block molds and a projection for molding a range on the other side of the annular groove in the ranges except for the range to be molded by the first mold block molds,
wherein in the second mold block, the parting surface abutting on the third mold block is formed in a direction of a normal line of the concave surface at a position where the parting surface and the concave surface intersect to each other, and
wherein in the third mold block, the parting surface abutting on the second mold block is formed in a direction of a normal line direction of the concave surface at a position where the parting surface and the concave surface intersect to each other.

2. A molding method of molding a molded product including an annular groove on an outer circumferential surface by a mold,
wherein the mold has three or more mold blocks, and each of the mold blocks includes a parting surface, a concave surface for molding a part of the outer circumferential surface, and a projection for molding a part of the annular groove, and wherein in each of the mold blocks, the parting surface is formed in a direction of a normal line of the concave surface at a position where the parting surface and the concave surface intersect to each other, and
wherein the molding method includes: a process of butting the parting surfaces on each other and molding the molded product; and a process of separating the parting surfaces from each other and bringing out the molded product.
